(19) United States
(12) Patent Application Publication
(10) Pub. No.: US 2005/0194266 A1
(43) Pub. Date: Sep. 8, 2005

(54) Gas bottle with protective casing for use in the medical field

(76) Inventors: Luc Peterolff, Paris (FR); Franck Virey, Paris (FR); Joseph Mazoyer, Sainte Foy les Lyon (FR)

Correspondence Address: Linda K. Russell;Air Liquide, Intellectual Property Department, 2700 Post Oak Blvd, Ste. 1800, Houston, TX, 77056, US

(21) Appl. No.: 11/036,459

(22) Filed: Jan. 14, 2005

Related U.S. Application Data
(63) Continuation of application No. 10/257,845, filed on Jun. 23, 2003, now abandoned.

(30) Foreign Application Priority Data
Apr. 17, 2000 (FR) 0004931

(51) Int. Cl. B65B 3/00; B65D 85/00; A62B 9/02

(52) U.S. Cl. 206/.6

(57) ABSTRACT

Portable gas delivery system intended for medical use. The gas delivery system has a gas cylinder with a bottle body and a gas flow controlling device. The gas cylinder body is partially covered by a first protective casing and the gas flow controlling device and/or the first protective covering are Partially covered with a second protective casing. A protective cowling also provides protection. Such protective casings may be joined together and have a disk shaped bottom portion to protect the bottom of the gas cylinder.

The present invention relates to a gas bottle on which means of controlling the inlet and outlet of gas are fixed, particularly a valve unit or a pressure reducing valve assembly, possibly equipped with a flow meter, preferably inserted in a protective cowling also mounted on the bottle, said bottle and said protective cowling and/or the means of controlling the inlet and outlet of gas being covered by one or more peripheral external protective casings consisting of one or more thicknesses, which may or may not be preassembled, guaranteeing the gas bottle thus equipped a high level of external cleanliness and hygiene.

Currently, bottles containing gas for medical use, laboratory gas and industrial gas are externally painted and generally marketed as is, that is to say with no external protection or overlapping.

Given the immaterial nature of the contents, namely colorless gases inside the bottle, the image of the product is conveyed only by its container.

Now, given that the bottle is subjected during its life cycle to numerous handlings and transport operations, both at the premises of the manufacturer and at those of the user, the external appearance of the bottle quickly suffers degradation giving this recyclable packaging an appearance of mediocre quality, which gives a devalued image of the product, particularly when the bottle contains a medical gas, such as a gaseous drug.

In addition, the wear resulting from use and recycling of a gas bottle over a somewhat lengthy period leads to a surface finish which, particularly while the bottle is in storage, encourages the retention of dust, dirt and various microorganisms and may pose health risks. Thus, the presence of germs on the sides of gas bottles used in a hospital environment may encourage the contraction of nosocomial diseases.

The problem which is therefore posed is that of being able to improve the external appearance, cleanliness and image of gas bottles, particularly when the bottle contains medical gas, laboratory gas used for analysis purposes, high-purity industrial gas for the electronics industry or gas that can be used for the manufacture of foodstuffs.

Certain solutions to this problem have already been proposed but none is entirely satisfactory.

For example, it is known practice to use a protective net made of plastic which is slipped directly over the cylindrical barrel of the bottle so as to protect it locally from impact. However, it has been found, in practice, that the net tends to deform if not changed regularly and therefore no longer performs its protective function. In addition, the net does not protect certain parts of the bottle, such as the protective cowling with which the bottle is equipped.

Furthermore, it has also been proposed for a thermoformed film to be arranged around the cylindrical barrel of the bottle. Although such a thermoformed film affords the bottle good protection, it does not give a sufficient guarantee in terms of hygiene, particularly since, on the one hand, this type of film is generally interrupted under the protective cowling and, on the other hand, below the barrel of the bottle, that is to say under its base, which leaves the bottom of the bottle and the means of controlling the outlet of gas therefrom unprotected. Furthermore, its placement, performed by hand, is industrially restrictive because it represents a lengthy operation.

Also known is for the bottle to be placed in a rigid cardboard casing which affords said bottle protection essentially during transport because, once the bottle has been delivered to the site at which it is to be used, the cardboard packaging is removed and discarded because it is often damaged or dirty. In other words, once the bottle has reached its place of use, it becomes devoid of any protection and, upon return having been emptied, it will once again suffer damage during transport.

Furthermore, it has also been proposed for the bottle at its place of use, particularly in at-risk areas such as operating theater complexes as far as bottles for medical use are concerned, to be placed in a fabric bag or a rigid metal container enveloping the barrel of the bottle. However, here again, the solution is not ideal because certain parts of the bottle are unprotected or are protected not very efficiently, particularly the protective cowling and the members it contains, such as a valve unit or a pressure reducing valve assembly.

Such solutions have been described in particular in the following documents U.S. Pat. No. 5,422,152, FR-A-2703434, FR-A-1512098, U.S. Pat. No. 3,787,993, EP-A-581665 or WO-A-98/16776.

Reference may also be made to documents U.S. Pat. No. 5,253,760, U.S. Pat. No. 3,921,872, U.S. Pat. No. 4,967,923, JP-A-07269790 and FR-A-2706140 which describe various technical solutions that can be applied to the transporting and/or protecting of compressed-gas bottles.

From there, the object of the invention is to solve the above problem by providing a solution which is more effective in terms of protection and the guaranteeing of hygiene than those taught in the prior art, so as to guarantee the gas bottles a high level of external cleanliness and hygiene.

The solution of the invention consists in a gas bottle comprising a bottle body of cylindrical overall shape comprising means of controlling the outlet of the gas and a protective cowling arranged around the means of controlling the outlet of the gas, characterized in that:
the bottle body is at least partially covered by at least a first protective casing, and
the protective cowling is at least partially covered by at least a second protective casing.

In another aspect, the invention relates also to a gas bottle comprising a bottle body of cylindrical overall shape comprising means of controlling the outlet of gas, characterized in that:
the bottle body is at least partially covered by at least a first protective casing, and
the means of controlling the outlet of gas are at least partially covered by at least a second protective casing.

In the context of the invention:
“means of controlling the outlet of gas” is the name given to the members which control the outlet of the gas contained in the bottle, such as on/off valves, gas valves, gas pressure reducers, combined gas pressure reducing valve assemblies and combined pressure reducing valve-flow meter assemblies.
“protective cowling” is the name given to any three-dimensional structure, generally rigid, able to provide the members or means of controlling the outlet of gas with mechanical protection against impacts of any kind; for example the cowling may have a simple “bell-housing” shape or a more complex shape such as the one described in document EP-A-747796.

As the case may be, the gas bottle of the invention may have one or more of the following features:
the bottle body is covered over at least 70% of its external surface area by at least the first protective casing and/or in that the protective cowling and/or the means of controlling the outlet of gas are covered over at least 70% of their external surface area by at least the second protective casing, and are preferably covered over between 80 and 98% of the surface area.
said first protective casing and second protective casing are a single protective casing and/or form a one-piece covering structure.
said first protective casing and second protective casing are separate and/or not attached to one another.
the second protective casing covering the means of controlling the outlet of gas comprises at least one cutout or precut allowing an operator to have access, through said cutout or precut to said means of controlling the outlet of gas under said second protective casing.
the second protective casing covering the protective cowling comprises at least one cutout or precut that coincides with and/or is placed opposite at least one opening in the protective cowling to allow an operator to have access, through said cutout or precut and said opening, to the means of controlling the outlet of gas which means are situated inside the protective cowling.
the first protective casing and/or the second protective casing are made of a sheet or structure of a material chosen from cardboard, varnished cardboard, plasticized cardboard, or a polymer.
the protective cowling and/or the means of controlling the outlet of gases are at least partially and temporarily covered by at least a third protective casing and/or a fourth protective casing; the third protective casing and/or the fourth protective casing are preferably made of a sheet or structure of a material chosen from polymers, preferably PET (polyethylene) or PVC (polyvinyl chloride), preferably PET.
the first protective casing and/or the second protective casing are themselves covered with a third external casing for temporary protection used while the bottle is being transported; said third casing preferably comprises one or more handles allowing an operator to carry a gas bottle using at least one handle.
the first protective casing has a disk-shaped bottom; said bottom is preferably rigid and/or made of polymer.
the first protective casing forms a sleeve able to encompass at least 80% of the body of the bottle. Furthermore, the invention also relates to protective packaging for a gas bottle, as such, formed of a first protective casing portion of rectangular shape to cover at least part of the cylindrical body of a gas bottle and of a second protective casing portion to cover at least part of the control members of said bottle and/or of a protective cowling protecting said control members, the first protective casing portion and said second protective casing portion being secured together and/or formed as a single piece, and the first casing portion further comprising a disk-shaped bottom fixed securely to said first casing portion so as to protect at least part of the bottom of the gas bottle.

As the case may be, the packaging of the invention may have one or more of the following features:
the first protective casing portion and said second protective casing portion are secured to one another and formed of a single piece of cardboard sheet, preferably a sheet of cardboard covered with a varnish or a polymer film.
at least the second protective casing portion has one or more cutouts or precuts.
the first protective casing portion has two longitudinal edges, at least one of said edges bearing at least one adhesive strip; said adhesive strip borne by one of said edges is preferably able to collaborate with the other of said edges; as a preference, the edge bearing said adhesive strip adheres by bonding to the other edge.

The solution of the invention, namely the fact of protecting not only the body of the gas bottle but also its upper part (cowling and/or means of controlling the outlet of gas) has the following advantages:
it is simple and quick for the manufacturer to fit once the bottle has been conditioned,
it allows the bottle, including the operating members, namely the valve, the pressure reducer and the various gas outlets, particularly in the case of a bottle with a built-in pressure reducing valve, to maintain a level of external cleanliness and hygiene over time,
it allows the affixing of special-purpose logos to qualify the gases, provide an identification code, give legal notices or any other useful information or wordings and labels that can be used to trace the bottle through the various successive users, without a risk of adversely affecting the surface of the bottle using inopportune and repeated markings,
it allows a quick inspection of the external appearance or the state of use of the bottle,
it allows the presence of a sealing device constituting a user guarantee system, and
it leads to a reduction in the time spent on repainting operations and on bottle maintenance down-time.

The invention will now be better understood by virtue of a detailed description of some embodiments which are illustrated in the appended figures.

The present invention relies on the fitting, around the cylindrical body 1 of the bottle and the protective cowling 2, of protective casings 11, 21, 30, each of which consist of one or more thicknesses which may or may not be preassembled.

One 21 of these casings, preferably rigid, protects the protective cowling 2 and the means 3 of controlling the outlet of gas, that is to say the operating members 3 of the bottle (valve, pressure reducer, outlets, etc.). This rigid part 21 may also protect part of the body 1 of the bottle, that is to say may extend along the body 1 of the bottle.

The bottles to which the invention relates are of varying sizes (typically with a capacity of up to about 50 liters of water) but preferably of small size, because small bottles (with a capacity of about 5 liters of water) are more likely to be carried around and handled by various operators and therefore to be subjected to various somewhat contaminating environments.

In the case of gas bottles for medical use, such a protective system falls within the context of pharmaceutical qualification of the product contained in the bottle.

Using one or more protective casings 11, 21, 30, 40 according to the present invention affords a solution to the following problems:
external attacks (scratching, flaky paint, etc.),
level of external cleanliness unsatisfactory and variable over time,
level of hygiene unsatisfactory and variable over time,
absence of pharmaceutical qualification of the product,
absence of special logos on the bottles to qualify the image of the gases according to the expectations of their respective markets,
absence of functionality such as stability of the bottle, protection of the operating members (valve, pressure reducer, outlets), obvious visual indication of the state of use of the bottle,
absence of protection of the paintwork of the body of the bottle, leading to maintenance costs,
absence of objective criteria against which to check the external appearance of the bottles during conditioning.

More specifically, according to the invention, the bottle is protected by a first protective casing 11 arranged around the body 1 of the bottle, a second protective casing 21 arranged around the protective cowling 2 and possibly a third casing 30 encompassing said first casing 11 and second casing 21, for example while the bottle is being transported or handled.

The first protective casing 11 constitutes an external thickness covering the body 1 of the bottle of a length equal to or approximately equal to the total height of the bottle that is to be protected and of a diameter slightly greater than the diameter of the bottle and the constituent material of which is either a polymer, preferably PET (polyethylene) and transparent, or a rigid cardboard casing, possibly varnished or plasticized, as detailed below.

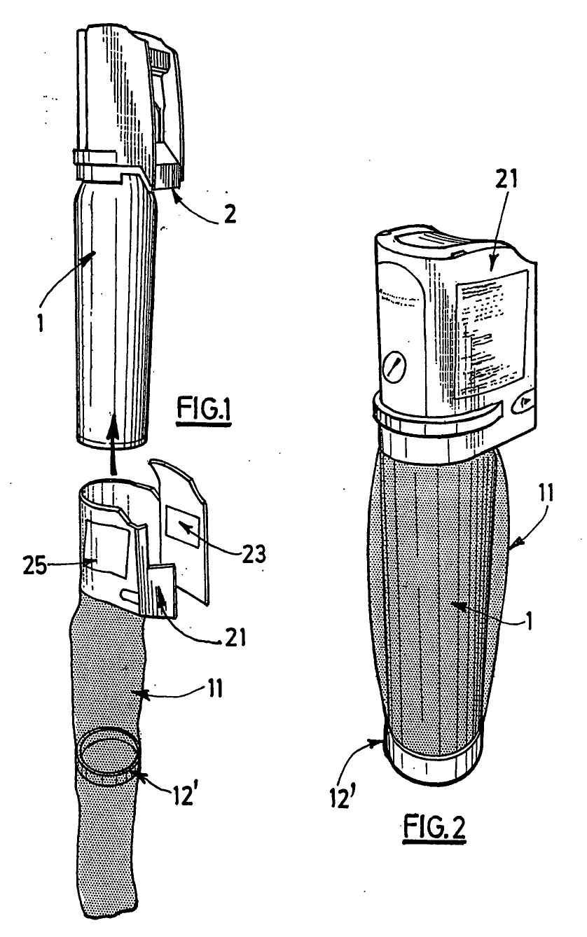

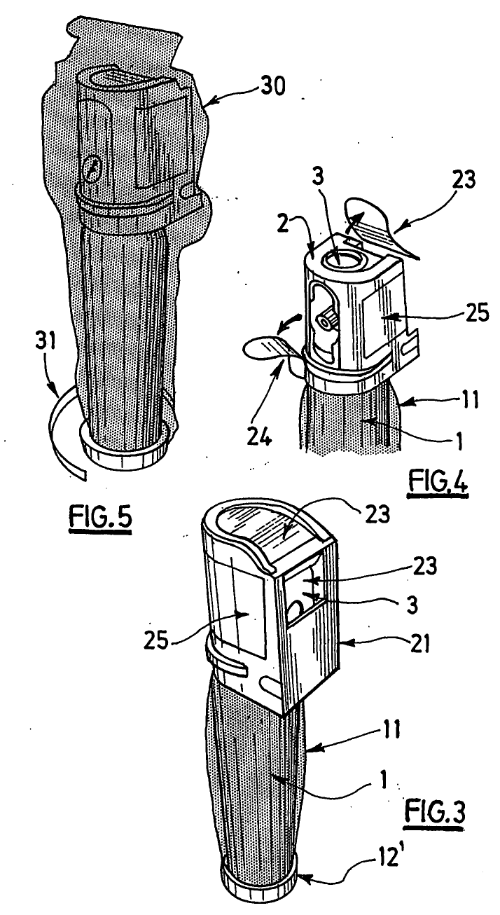

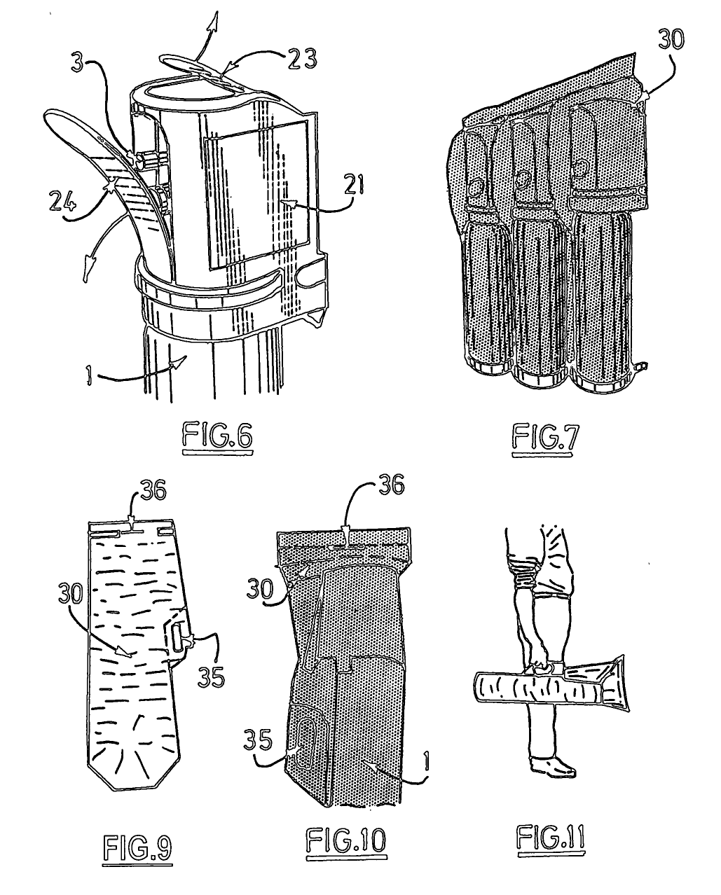

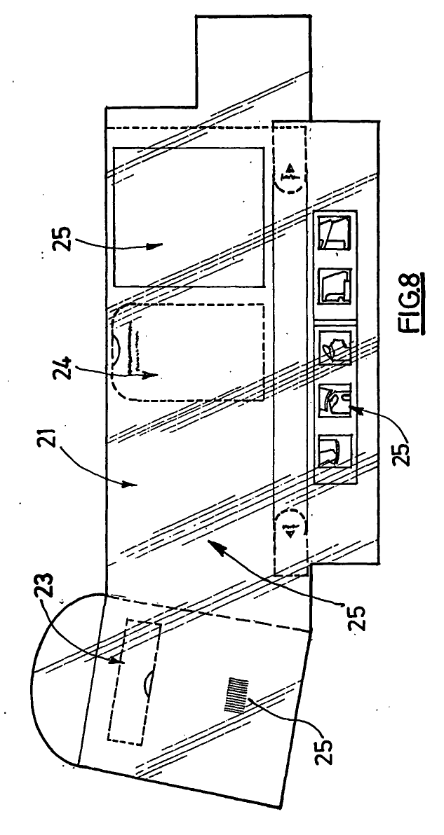

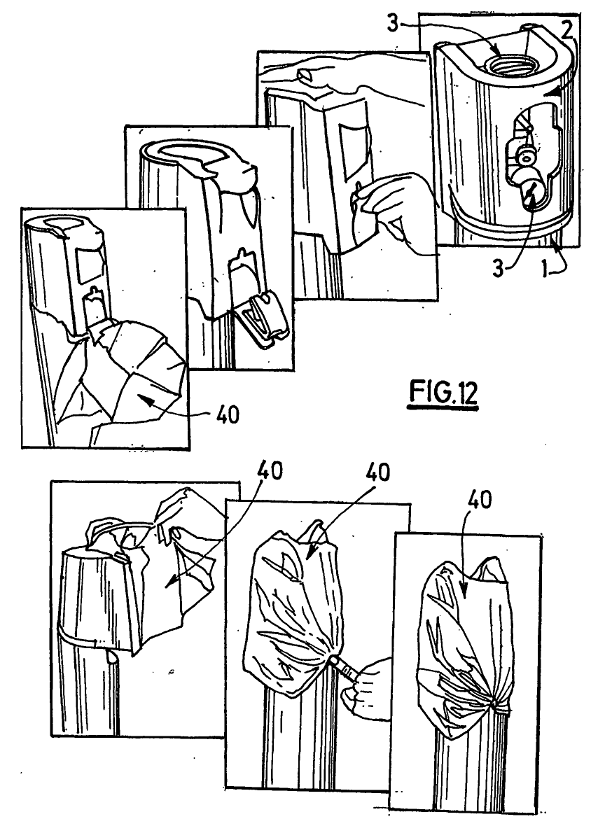

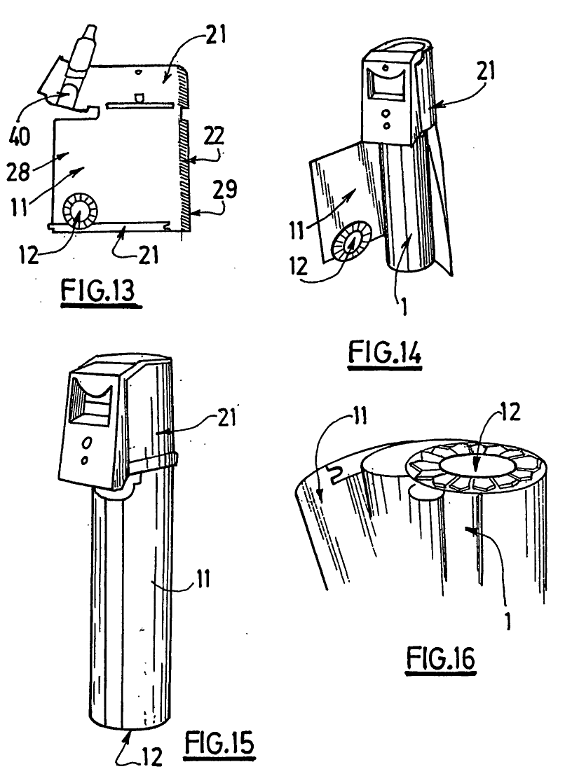

Furthermore, as shown in FIGS. 13 to 16, this first protective casing 11 surrounding the body 1 of the bottle preferably comprises a rigid and flat bottom 12 which, on the one hand, makes said first casing 11 easier to fit around the bottle and, on the other hand, stabilizes the bottle when it is placed in a vertical position. In addition, the presence of a bottom 12 secured to the first casing 11 makes it possible to enhance the hygiene of the bottle by preventing dust or other dirt from infiltrating between the body 1 of the bottle and said protective casing.

As detailed in FIG. 13, the protective packaging 11, 21, viewed here from its inside, that is to say from the side in contact with the body 1 of the bottle, is formed of a first protective casing portion 11 of rectangular overall shape to cover the cylindrical body of a gas bottle and of a second protective casing portion 21 to cover at least part of the protective cowling 2 protecting the control members 3. The first protective casing portion 11 and the second protective casing portion 21 are secured to one another and formed as a single piece of cardboard sheet covered externally with a varnish or with a polymer film. The first casing portion 11 carries the disk-shaped bottom 12 fixed securely to said first casing portion 11 via a plastic strip 21, itself fixed, for example by bonding, to the sheet that forms the first casing portion 11. When the packaging is fitted around the bottle, the two ends of the strip 21 may be joined together by clipping. Furthermore, an adhesive strip 22 is provided on one of the longitudinal edges of the first casing portion 11 to allow it to be arranged and fixed in position around the body 1 of the bottle, the edge 29 with the adhesive strip 22 covering the edge 28 without adhesive strip and bonding thereto, via said adhesive strip 22.

However, in some cases, the presence of a flat bottom 12 is not necessary and it is possible either to add nothing further or to add just one or more annular rings 12′ which hug the base of the first casing 11, near the bottom of the bottle.

The second protective casing 21 constitutes a thickness guaranteeing the members or means 3 of controlling the outlet of gases contained in the bottle, for example a valve or a gas pressure-reducing valve assembly, a high level of hygiene. When said members or means of controlling the outlet of gases are protected by a protective cowling 2, then this second protective casing 21 covers all or part of the external surface of said protective cowling 2, or may also even cover part of the body of the bottle. The second protective casing 21 may have a cardboard rigid part, for example made of plasticized or varnished cardboard. Notches or precuts 23, 24, blanked off before entry into service, are provided on this rigid second protective casing 21 to allow the operator to access the operating members 3 of the bottle (valve, pressure reducer, outlets). This disposable or non-disposable thickness 21 may bear special-purpose graphics 25, the quality of which is renewed on each conditioning operation.

Furthermore, a third thickness 30, the constituent material of which may be a polymer, preferably PET, varnished cardboard or plasticized cardboard, protects the bottle partially or in full while it is being transported from the conditioning and packaging center to its place of use (hospital, care center or mobile emergency medical service, for example) or alternatively to a storage site prior to use. The other protective casings 11 and 21 may nonetheless be used without this last thickness 30. This third disposable or non-disposable thickness 30 may also bear specific graphics the quality of which is renewed on each conditioning operation. As this thickness 30 is supposed to afford the bottle full protection during transport and storage, it has therefore to be sufficiently strong. It could, if need be, be used alone if the level of hygiene expected by the user is not high. This thickness is provided with a lateral handle which allows the bottle to be carried horizontally with ease.

Finally, a fourth thickness 40, added to the bottle after the gas which is contained in said bottle has been used, makes it possible very visibly to embody the state of use of the bottle (empty/return to the manufacturer) from information that is visible from afar, thus avoiding any unintentional handling of a bottle which has already been used. As a preference, such a fourth thickness 40 covers at least part of the second protective casing 21 when the bottle is empty, as far as the site at which this bottle is refilled. Advantageously, this fourth thickness 40 is of a vivid color (for example orange or red) or has special markings which indicate the condition of the bottle clearly to the user at a simple glance.

In general, the number of protective thicknesses is directly linked to the desired level of hygiene and to the life cycle of the bottle between two successive conditioning operations.

The protective casings make it possible to maintain the level of external cleanliness and hygiene of the bottle over time. They are therefore associated with an overall usage protocol which involves several phases, namely:
at the premises of the manufacturer of gas for medical use: at the end of the filling of the bottle and of the related checks, the protective casings, preferably disposable, are fitted to the bottle.
during transport: the devices for storing the bottles on the trucks will be adapted if necessary so as not to damage the protective casings during transport.
at the premises of the user: the bottle is delivered as is to the user who retains all of the protective casings throughout the storage time. At the time of use of the product, the user removes the third thickness 30. The bottle then reveals the first and second casings 11 and 21. The conditioned product offered with guarantees of cleanliness is thus protected throughout its use. Once the bottle has been emptied, the user arranges a fourth thickness 40, preferably colored (orange or red) to indicate the state of use of the bottle. The bottle is thus protected while it is being returned to the conditioning center.
at the premises of the manufacturer of gas for medical use: the user places the bottle at the disposal of the manufacturer for return to the conditioning center. The colored fourth protective casing 40 is removed prior to conditioning when the bottles are being sorted.

During the reconditioning of the bottles, the bottle casings are preferably systematically exchanged for new clean casings.

As a preference, in the case of small bottles, means allowing the bottle to be carried with a lateral handle 35, 36 (or several of these) situated on the outermost protective casing 30 are provided and this allows quick and easy removal after each operation of conditioning at the premises of the manufacturer.

As an option, in order to improve the level of hygiene, it is possible, when conditioning the gas, either for the packaging to be impregnated with a disinfectant product or for the packaging and the bottle (body and control members) to be treated with a disinfecting and/or cleaning solution.

The invention is particularly well suited to use within a hospital or care establishment, or an on-site intervention unit, particularly a mobile unit of the emergency medical services type.

1-17. (canceled)

18. An apparatus which may be used as a gas delivery system, said apparatus comprising:
a) a gas cylinder, wherein said cylinder comprises a cylinder body;
b) a gas flow control means for controlling the gas flow exiting said cylinder;
c) a protective cowling, wherein said cowling is substantially located around said control means;
d) a first protective casing, wherein said cylinder body is at least partially covered by said first protective casing;
e) a second protective casing, wherein said cowling is at least partially covered by said second protective casing.

19. An apparatus which may be used as a gas delivery system, said apparatus comprising:
a) a gas cylinder, wherein said cylinder comprises a cylinder body;
b) a gas flow control means for controlling the gas flow exiting said cylinder;
c) a first protective casing, wherein said cylinder body is at least partially covered by said first protective casing;
d) a second protective casing, wherein said gas flow control means is at least partially covered by said second protective casing.

20. The apparatus of claim 18, wherein:
a) said first protective casing covers at least about 70% of said cylinder body's external surface area; and
b) said second protective casing covers at least about 70% of said cowling's external surface area.

21. The apparatus of claim 20, wherein said second protective casing covers about 80% to about 98% of said cowling's external surface area.

22. The apparatus of claim 19, wherein:
a) said first protective casing covers at least about 70% of said cylinder body's external surface area; and
b) said second protective casing covers at least about 70% of said gas flow control means' external surface area.

23. The apparatus of claim 22, wherein said second protective casing covers about 80% to about 98% of said gas flow control means' external surface area.

24. The apparatus of claim 20, where said first protective casing and said second protective casing are joined together to form a single protective casing.

25. The apparatus of claim 22, where said first protective casing and said second protective casing are joined together to form a single protective casing.

26. The apparatus of claim 20, wherein said first protective casing and said second protective casing are not joined together.

27 The apparatus of claim 22, wherein said first protective casing and said second protective casing are not joined together.

28. The apparatus of claim 27, wherein:
a) said second protective casing comprises at least one second casing cutout; and
b) said second casing cutout is located so as to allow an operator access to said gas flow control means.

29. The apparatus of claim 26, wherein:
a) said second protective casing comprises at least one second casing cutout;
b) said protective cowling comprises at least one cowling cutout; and
c) said cowling cutout and said second casing cutout are located so as to allow an operator access to said gas flow control means.

30. The apparatus of claim 18, wherein said gas flow control means comprises at least one member selected from the group consisting of:
a) on/off valves;
b) gas valves;
c) gas pressure reducers;
d) gas pressure reducing valve assemblies; and
e) gas pressure reducing valve flow meter assemblies.

31. The apparatus of claim 19, wherein said gas flow control means comprises at least one member selected from the group consisting of:
a) on/off valves;
b) gas valves;
c) gas pressure reducers;
d) gas pressure reducing valve assemblies; and
e) gas pressure reducing valve flow meter assemblies.

32. The apparatus of claim 18, wherein:
a) said first protective casing and said second protective casing are made from a material; and
b) said material comprises at least one member selected from the group consisting of:
1) cardboard;
2) varnished cardboard;
3) plasticized cardboard; and
4) polymer film.

33. The apparatus of claim 32, wherein:
a) said first protective casing is in the form of a sleeve; and
b) said first protective casing covers at least about 80% of said cylinder body.

34. The apparatus of claim 19, wherein:
a) said first protective casing and said second protective casing are made from a material; and
b) said material comprises at least one member selected from the group consisting of:
1) cardboard;
2) varnished cardboard;
3) plasticized cardboard; and
4) polymer film.

35. The apparatus of claim 34, wherein:
a) said first protective casing is in the form of a sleeve; and
b) said first protective casing covers at least about 80% of said cylinder body.

36. The apparatus of claim 18, wherein:
a) said apparatus further comprises:
1) a third protective covering; and
2) a fourth protective covering;
b) said third and said fourth protective coverings cover at least part of at least one element selected from the group consisting of:
1) said protective cowling; and
2) said gas control means; and
c) said third and fourth protective coverings are made from a polymer.

37. The apparatus of claim 36, wherein said polymer comprises PET or PVC.

38. The apparatus of claim 19, wherein:
a) said apparatus further comprises:
1) a third protective covering; and
2) a fourth protective covering;
b) said third and said fourth protective coverings cover at least part of said gas control means; and
c) said third and fourth protective coverings are made from a polymer.

39. The apparatus of claim 39, wherein said polymer comprises PET or PVC.

40. The apparatus of claim 18, further comprising an external casing, wherein:
a) said external casing substantially covers said first and said second protective casings;
b) said external casing comprises at least one handle; and
c) said handle is suitable for allowing an operator to carry said apparatus.

41. The apparatus of claim 19, further comprising an external casing, wherein:
a) said external casing substantially covers said first and said second protective casings;
b) said external casing comprises at least one handle; and
c) said handle is suitable for allowing an operator to carry said apparatus.

42 The apparatus of claim 18, wherein said first protective casing comprises a disk shaped bottom portion.

43 The apparatus of claim 42, wherein said disk shaped portion is rigid and made of polymer.

44 The apparatus of claim 19, wherein said first protective casing comprises a disk shaped bottom portion.

45 The apparatus of claim 44, wherein said disk shaped portion is rigid and made of polymer.

46. An apparatus which may be used as protective packing for a gas cylinder, said apparatus comprising:
a) a first protective casing, wherein said first protective casing:
1) is of a rectangular shape;
2) is suitable to protect at least part of the body of a gas cylinder;
3) comprises a disk shaped bottom portion, wherein said disk shaped portion is suitable to protect at least part of said gas cylinder's bottom; and
b) a second protective casing, wherein said second protective casing:
1) is joined to at least part of said first protective casing; and
2) is suitable to protect at least part of said gas cylinder's control members.

47. The apparatus of claim 46, further comprising a protective cowling, wherein said protective cowling is suitable to protect at least part of said control members.

48. The apparatus of claim 46, wherein said first protective casing and said second protective casing are completely joined together so as to form a single protective casing.

49. The apparatus of claim 20, wherein said first protective casing and said second protective casing are formed from a single cardboard sheet.

50. The apparatus of claim 49, wherein:
a) said cardboard sheet is covered with a film;
b) said film comprises at least one member selected from the group consisting of:
1) a varnish; and
2) a polymer film.

51. The apparatus of claim 46, wherein said second protective casing comprises at least one second casing cutout.

52. The apparatus of claim 46, wherein:
a) said first protective casing comprises at two longitudinal edges; and
b) at least one said edge comprises at least one adhesive strip.

53. The apparatus of claim 52, wherein said adhesive strip is able to substantially cooperate with either said edge.

54. A method which may be used for delivering a gas cylinder to a health care facility, said method comprising delivering a specially packaged gas cylinder to a health care facility, wherein:
a) said special packaging comprises:
1) a first protective casing, wherein said first protective casing:
i) is of a rectangular shape;
ii) protects at least part of the body of said gas cylinder; and
iii) comprises a disk shaped bottom portion, wherein said disk shaped portion protects at least part of said gas cylinder's bottom; and
2) a second protective casing, wherein said second protective casing:
i) is joined to at least part of said first protective casing; and
ii) protects at least part of said gas cylinder's control members; and
b) said health care facility comprises at least one member selected from the group consisting of:
1) a hospital;
2) a primary health care establishment;
3) an on-site emergency response unit; and
4) a mobile emergency medical service unit.
